(19) United States
(12) Patent Application Publication
(10) Pub. No.: US 2008/0082345 A1
(43) Pub. Date: Apr. 3, 2008

(54) System and method for evaluating risks associated with delaying machine maintenance

(75) Inventors: Jonny Ray Greiner, Dunlap, IL (US); Giles Kent Sorrells, Metamora, IL (US); Richard Lee Gordon, East Peoria, IL (US); Anthony James Grichnik, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,239

(22) Filed: Sep. 29, 2006

(51) Int. Cl. G06Q 10/00; G06Q 30/00

(52) U.S. Cl. 705/1

(57) ABSTRACT

A method for determining risk associated with delaying machine maintenance includes receiving health data associated with a machine and analyzing the health data based on predetermined threshold data to detect an event alert condition. A future failure date of a machine component is then estimated based on the health data analysis. Historic productivity data associated with the machine is analyzed and a cost associated with operating the machine with the event alert condition for a predetermined amount of time is estimated. A cost associated with removing the machine from service is predicted based on historic productivity analysis. The estimated cost associated with removing the machine from service is then analyzed based on the estimated cost associated with operating the machine with the event alert condition. A machine repair recommendation indicative of the cost analysis is provided.

### TECHNICAL FIELD

This application relates generally to financial analysis systems and, more particularly, to a system and method for evaluating financial risks associated with delaying machine maintenance.

### BACKGROUND

Many industries such as, for example, mining, construction, agriculture, energy, transportation, etc., often rely on expensive machinery to perform tasks associated with a particular project or project environment. In order to justify the cost associated with the purchase and operation of this machinery, many organizations require continuous or near-continuous operation of the machinery over the duration of the project.

In most project environments, the financial success of the project depends upon the completion of the project according to certain project parameters, such as schedule or project budget. In an effort to maximize profits and control costs, managers may schedule tasks and budget resources according to these parameters. Because modifications to the schedule or budget may adversely affect profits, managers closely monitor project operations, task status, and equipment health to ensure that the project is meeting established schedule and performance benchmarks. Any unscheduled delay or lapse in productivity of the project, such as, for example, machine down-time and/or unscheduled machine maintenance, may result in the project exceeding the schedule and/or budget, potentially impacting profitability.

In an effort to minimize unscheduled delay and productivity lapses, some managers or machine operators opt to temporarily ignore machine diagnostic event alerts. Although temporarily ignoring these alerts (and any potential problems associated therewith) may be an effective means for minimizing unscheduled delay in some cases, it may prove costly in other situations. For example, if an event alert indicative of a major machine malfunction is ignored, a problem that may be remedied with relatively minor delay and inexpensive repair procedure, may quickly escalate into a potentially major problem that may require expensive repairs and prolonged machine outage. Thus, in order to minimize unscheduled delay due to machine maintenance or repair without unnecessarily damaging the machine, a system and method for evaluating risks associated with delaying machine maintenance, may be required.

At least one system has been developed for determining a maintenance schedule for components of an equipment system based on certain predictive maintenance factors associated with the components. For example, U.S. Pat. No. 6,738,748 (“the '748 patent”) to Wetzer describes a system for managing maintenance of equipment. The system includes a maintenance controller that determines a predictive maintenance factor based on usage data associated with the component. The system also includes a scheduler for scheduling maintenance of a machine based on a predictive maintenance factor associated with the component. The predictive maintenance factor includes a simple estimate of the remaining “life” of the component, which is predicted based on a predetermined (i.e., manufacturer specified) expiration date for the component. The predictive maintenance factor may also include a cost estimate associated with labor costs, current repair costs, future (i.e., inflated) repair costs, etc.

Although the system of '748 patent may evaluate certain performance factors in an effort to determine an appropriate maintenance schedule for a component, it may have significant limitations. For instance, the system of the '748 patent only monitors usage data (i.e., hours of operation, total operation time, etc.) associated with the equipment, but does not monitor health or operating conditions of the components or the equipment. As a result, should a component associated with the equipment of the '748 patent experience a fault condition prior to the estimated expiration time, the preventative maintenance system of the '748 patent may do nothing to respond to the fault. In fact, because the system of the '748 patent does not collect health data, the fault condition may go undetected, potentially resulting in premature equipment failure and unscheduled equipment down-time.

Furthermore, the system of the '748 patent does nothing to evaluate the financial risks associated with the delaying action on certain problematic machine operations based on prognostic and/or historical data. As a result, a project manager operating under a tight project schedule may unnecessarily remove a machine with an “expired” component for maintenance or repair, even if the financial impact of the machine removal outweighs potential damage caused by the continued operation of the machine with the expired component.

The presently disclosed system and method for evaluating risks associated with delaying machine maintenance are directed toward overcoming one or more of the problems set forth above.

### SUMMARY OF THE INVENTION

In accordance with one aspect, the present disclosure is directed toward a method for determining risk associated with delaying machine maintenance. The method may include receiving health data associated with a machine and analyzing the health data based on predetermined threshold data to detect an event alert condition. A future failure date of a machine component may be estimated based on the health data analysis. Historic productivity data associated with the machine may be analyzed and a cost associated with operating the machine with the event alert condition for a predetermined amount of time is estimated. A cost associated with removing the machine from service may also be predicted based on historic productivity analysis. The estimated cost associated with removing the machine from service may be analyzed based on the estimated cost associated with operating the machine with the event alert condition. A machine repair recommendation based on the cost analysis may be provided.

According to another aspect, the present disclosure is directed toward a system for evaluating risks associated with delaying machine maintenance. The system may include a communication interface for receiving health data associated with a machine and a processor communicatively coupled to the communication interface. The processor may be configured to analyze the health data based on predetermined threshold data and estimate a future failure date of a machine component based on the health data analysis. The processor may also be configured to analyze historic productivity data associated with the machine and estimate a cost associated with operating the machine with an event alert condition for a predetermined amount of time. Based on historic productivity analysis, a cost associated with removing the machine from service may be estimated. The processor may be further configured to analyze the estimated cost associated with removing the machine from service based on the estimated cost associated with operating the machine with the event alert condition. The processor may provide a machine repair recommendation based on the cost analysis.

In accordance with yet another aspect, the present disclosure may be directed toward a machine environment that includes a machine, a communication module for communicating data associated with the machine, and at least one monitoring device for collecting health data associated with at least one component of the machine and subsequently providing the health data to the communication module. The machine environment may also include a system, communicatively coupled to the communication module, for evaluating risks associated with delaying machine maintenance. The system may be configured to receive health data associated with a machine and analyze the health data based on predetermined threshold data. The system may also be configured to estimate a future failure date of a machine component based on the health data analysis and estimate a cost and duration associated with repairing the machine. The system may be further configured to analyze historic productivity data associated with the machine and estimate a cost associated with removing the machine from service based on historic productivity analysis and the estimated repair duration. The estimated cost associated with removing the machine from service may be compared with the estimated cost associated with repairing the machine. The system may provide a recommendation to remove the machine from service if the estimated cost associated with operating the machine until the future failure date exceeds the estimated cost associated with removing the machine from service. Alternatively, if the estimated cost associated with removing the machine from service exceeds the estimated cost associated with operating the machine until the future failure date, the system may provide a recommendation to operate the machine until the future failure date.

### BRIEF DESCRIPTION OF THE DRAWINGS

FIG. 1 illustrates an exemplary disclosed machine environment consistent with certain disclosed embodiments;

FIG. 2 provides a schematic illustration of an exemplary risk evaluation system in accordance with certain disclosed embodiments; and

FIG. 3 illustrates a flowchart depicting an exemplary method for evaluating financial risks associated with delaying machine maintenance.

### DETAILED DESCRIPTION

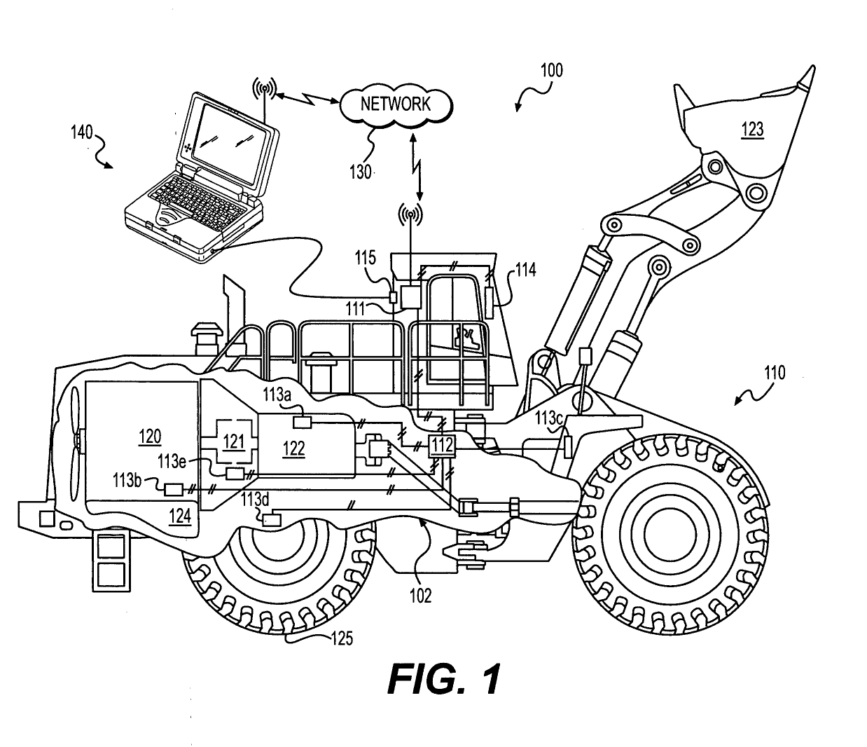

FIG. 1 illustrates a machine environment 100 according to an exemplary disclosed embodiment. Machine environment 100 may include any environment in which one or more machines 110 perform a task associated with an industry such as mining, construction, transportation, energy exploration, farming, or any other type of industry. For example, machine environment 100 may include one or more mine sites in which one or more machines 110 cooperate to perform a task associating with the completion of a mining project.

Machine environment 100 may include a machine 110, a risk assessment system 140, and a communication network 130 for providing data communication between machine 110 and a risk assessment system 140. Although risk assessment system 140 is illustrated as a standalone, off-board system with respect to machine 110, it is contemplated that risk assessment system 140 may include any back-end system that includes computer systems and alert monitoring equipment. It is further contemplated that machine environment 100 may include additional, fewer, and/or different components than those listed above. For example, machine environment 100 may include additional machines and/or machine types.

Machine 110 may include any fixed or mobile machine for performing a task associated with machine environment 100. For example, machine 110 may include a mobile earth moving machine such as a wheel loader, a track-type tractor, a dozer, a motor grader, an excavator, or any other type of machine. Alternatively and/or additionally, machine 110 may include a stationary machine such as a generator set, a pumping device, a turbine, or any other suitable type of stationary machine.

In one embodiment, machine 110 may include one or more components or component systems configured to collect and distribute information associated with machine 110 across machine environment 100. For example, machine 110 may include an on-board monitoring system 102, a display console 114, a communication module 111, and a direct data link 115 configured to communicate with a risk evaluation system 140 via communication network 130. It is contemplated that one or more of on-board monitoring system 102, direct data link 115, and communication module 111 may be integrated as a single unit. It is further contemplated that machine 110 may include additional, fewer, and or different components than those listed above.

Communication module 111 may include any device configured to facilitate communication between system 102 and risk assessment system 140. Communication module 111 may include hardware and/or software that enables communication modules 111 to transmit and/or receive data messages through direct data link 115 and/or via communication networks 130. Communication module 111 may include, for example, a network interface (not shown), a wireless transceiver (not shown), and a processor (not shown) configured to collect and distribute data associated with machine 110.

Communication networks 130 may include any wired and/or wireless communications suitable for data transmission such as, for example, satellite, cellular, point-to-point, point-to-multipoint, multipoint-to-multipoint, Bluetooth, RF, Ethernet, fiber-optic, coaxial, and/or waveguide communications. Alternatively and/or additionally, communication network 130 may include a direct data link 115, serial, parallel, USB, Ethernet, fiber-optic, fire-wire, Bluetooth, or any other type or combination of transmission mediums suitable for direct transfer of information.

On-board monitoring system 102 may include one or more components configured to collect information associated with machine 110 during operation. For example, on-board monitoring system 102 may include one or more sensing devices 113a-e communicatively coupled to a on-board controller 112. On-board monitoring system 102 may correspond to an electronic control module (ECM) associated with machine 110 or, alternatively, may embody a standalone unit dedicated to the collection and distribution of machine data. It is contemplated that on-board monitoring system 102 may include additional and/or different components than those listed above.

Display console 114 may be communicatively coupled to communication module 111 and may include any audio, video, and/or combination audio-video device suitable for communicating information associated with machine environment 100 to a machine operator. For example, display console may include one or more LCD, CRT, plasma, or any other type of display monitor with a graphical user interface (GUI), one or more indicator lights, and/or an audio device (e.g., speaker, microphone, headset, etc.) that provides operation data associated with a component or subsystem of machine 110 to a machine operator. Alternatively and/or additionally, display console 114 may relay dispatch information (i.e., maintenance and/or repair information, shift change schedules, etc.), operational instructions and/or recommendations, job site data (weather, soil conditions, temperature, etc.), payload information, productivity data, or any other type of information. It is also contemplated that display console 114 may display software applications and/or operator assistance tools (e.g., training tools, etc.) executed by communication module 111 and/or an on-board controller 112. For purposes of the present disclosure, the term maintenance refers to any service, scheduled or unscheduled, which may be performed on a machine including, among other things, electrical and/or mechanical repairs, scheduled service procedures, system or component updates and/or upgrades, or any other type of service performed in association with machine 100 or any of its constituent components.

Sensing devices 113a-e may include any type of sensor or sensor array and may be associated with one or more components of machine 110 such as, for example, a power source 120, a torque converter 121, a transmission 122, a work implement 123, a fluid supply 124, a traction device 125, and/or other components and subsystems of machine 110. Sensing devices 113a-e may be configured to automatically gather operation data associated with one or more components and/or subsystems of machine 110 such as, for example, implement, engine, and/or machine speed and/or location; fluid pressure, flow rate, temperature, contamination level, and or viscosity of a fluid; electric current and/or voltage levels; fluids (i.e., fuel, oil, etc.) consumption rates; loading levels (i.e., payload value, percent of maximum payload limit, payload history, payload distribution, etc.); transmission output ratio, slip, etc.; grade; traction data; scheduled or performed maintenance and/or repair operations; and any other suitable operation data. It is contemplated that sensing devices may be associated with additional, fewer, and/or different components and/or subsystems associated with machine 110 than those listed above.

According to one embodiment, on-board controller 112 may be communicatively coupled to each of sensing devices 113a-e and may include one or more components configured to monitor, record, store, sort, filter, analyze, and/or communicate operation data associated with machine 110 and/or its components and subsystems. These components may include a memory, one or more data storage devices, a central processing unit, a communication interface, or any other components configured to execute an application. For example, on-board controller 112 may correspond to an integrated control module associated with machine 110, such as an electronic control module (ECM) or any other suitable machine control device.

On-board controller 112 may include an electronic control unit of machine 110 and may be communicatively coupled to one or more systems and subsystems of machine 110. As such, on-board controller 112 may be configured to control operations of certain components and subsystems. For example, on-board controller 112 may be communicatively coupled to a fuel injection system associated with a combustion engine of machine 110. On-board controller 112 may be receive an operator command (e.g., increase throttle, etc.) and provide these command signals to the fuel injection system, which may subsequently increase the flow of fuel into the combustion chamber. It is contemplated that, in certain conditions, on-board controller 112 may receive commands directly from risk assessment system 140 and/or may generate these commands based on certain operation data associated with machine 110.

On-board controller 112 may include one or more software programs configured to analyze operation data collected from sensing devices 113a-e based on predetermined threshold data stored in memory. For example, on-board controller 112 may compare operation data for a particular component or system with predetermined threshold data indicative of normal (i.e., manufacturer specified, design specified, etc.) operation of the particular component or system. Predetermined threshold data, as the term is used herein, refers to any value, limit, range, etc. that establishes an acceptable level of operation associated with a particular component or system. If the operation data is inconsistent with a the predetermined threshold data, on board controller 112 may provide a warning signal (including any associated trouble/error codes) to risk assessment system 140. The operation data may be determined to be inconsistent with the predetermined threshold data if the operation data is greater than a predetermined threshold value, less than a predetermined threshold value, and/or outside a predetermined threshold range. For instance, data indicative of engine oil pressure may be compared with a predetermined acceptable range. If the oil pressure is outside this range (i.e., lower than a lower range limit or higher than an upper range limit), the oil pressure data is determined to be inconsistent with the predetermined threshold data associated with oil pressure.

According to one embodiment, on-board controller 112 may include one or more software programs for performing diagnostic analysis of machine data. For example, based on the comparison of operation data, one or more trouble codes may be generated. On-board controller 112 may determine, based on the trouble codes, potential causes and/or predetermined courses of action to resolve the trouble code. For example, on-board controller 112 may detect an elevated tire pressure on one or more tires associated with machine 110, which exceeds a predetermined threshold for tire pressure. On-board controller 112 may generate a trouble code associated with the elevated tire pressure. Based on the trouble code, diagnostic software associated with on-board controller 112 may determine that the machine's ground speed is too high, resulting in increased air temperature within the tires. As a result, on-board controller 112 may notify an operator of machine 110 to limit the speed of the machine. Alternatively and/or additionally, on-board controller 112 may transmit a speed limiting signal to one or more of the engine and/or transmission of machine 110 to control the speed of the vehicle until the tire pressure returns to an appropriate level.

According to another embodiment, on-board controller 112 may include one or more software programs for performing prognostic analysis of machine data. For example, on-board controller 112 may analyze current operation data associated with a particular component or subsystem with historical data associated with previous operations of the component. Based on this analysis, performance trends in the operation of the component or system may be identified and compared with failure analysis test data for the particular component, to determine if the performance trend may be indicative of a potential problem. If a potential problem is identified, a prognostic event signal may be provided to risk assessment system 140, for further investigation.

Risk assessment system 140 may include one or more computer systems configured to collect, monitor, analyze, evaluate, store, record, and transmit operation data associated with machine 110. Risk assessment system 140 may be associated with one or more business entities associated with machine 110 such as a manufacturer, an owner, a project manager, a dispatcher, a maintenance facility, a performance evaluator, or any other entity that generates, maintains, sends, and/or receives information associated with machine 110. Although risk assessment system 140 is illustrated as a laptop computer, it is contemplated that risk assessment system 140 may include any type of computer system such as, for example, a desktop workstation, a handheld device, a personal data assistant, a mainframe, or any other suitable computer system.

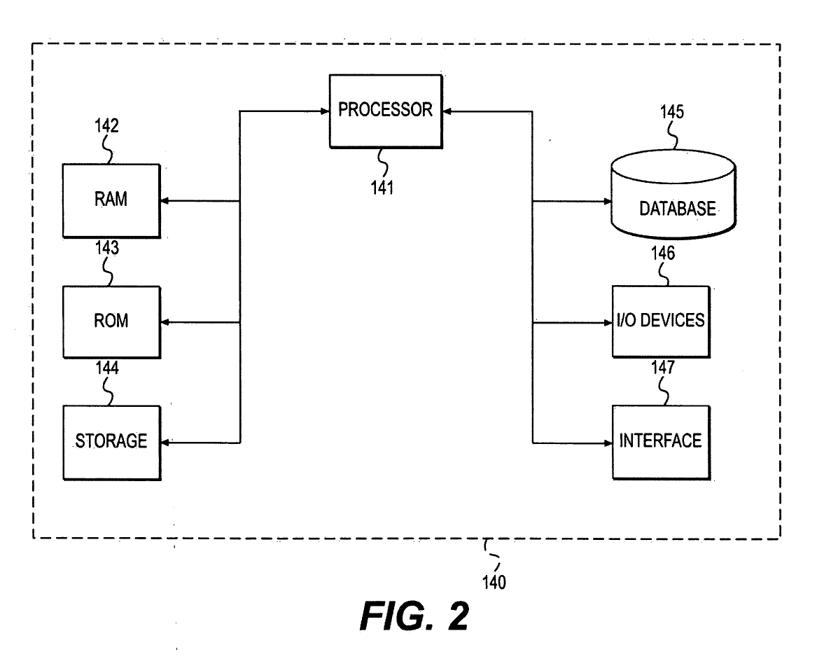

As explained, risk assessment system 140 may include one or more computer systems and/or other components for executing software programs. For example, as illustrated in FIG. 2, risk assessment system may include a processor (i.e., CPU) 141, a random access memory (RAM) 142, a read-only memory (ROM) 143, a storage 144, a database 145, one or more input/output (I/O) devices 146, and an interface 147. It is contemplated that risk assessment system 140 may include additional, fewer, and/or different components than those listed above. It is understood that the type and number of listed devices are exemplary only and not intended to be limiting.

CPU 141 may include one or more processors that can execute instructions and process data to perform one or more functions associated with risk assessment system 140. For instance, CPU 141 may execute software that enables risk assessment system 140 to request and/or receive operation data from one or more sensing devices 113a-e. CPU 141 may also execute software that enables risk assessment system 140 to further analyze one or more diagnostic and/or prognostic alerts to determine a potential preventative maintenance plan. CPU 141 may also execute software that schedules preventative machine maintenance and repair and transmits the schedule to an operator of machine 110 via display console 114. CPU 141 may also execute software that generates, archives, and/or maintains maintenance schedules, prognostic alarms, historical operation data, or any other type of information associated with machine 110.

Storage 144 may include a mass media device operable to store any type of information needed by CPU 141 to perform processes associated with operational monitoring system 140. Storage 144 may include one or more magnetic or optical disk devices, such as hard drives, CD-ROMs, DVD-ROMs, or any other type of mass media device.

Database 145 may include one or more memory devices that store, organize, sort, filter, and/or arrange data used by risk assessment system 140 and/or CPU 141. For example, database 145 may store historical performance data associated with a particular machine 110. Database 145 may also store benchmark and/or other data values associated with machine performance. Database 145 may also store operational parameters for each component or system of components associated with machine 110, including normal operating ranges for the components, threshold levels, etc.

Input/Output (I/O) devices 146 may include one or more components configured to interface with a user associated with machine environment 100. For example, input/output devices 146 may include a console with integrated keyboard and mouse to allow a user of risk assessment system 140 (e.g., customer, client, project manager, etc.) to input one or more benchmark values, modify one or more operational specifications, and/or machine operation data. Risk assessment system 140 may store the performance, productivity, and/or operation data in storage 144 for future analysis and/or modification.

Interface 147 may include one or more elements configured for communicating data between risk assessment system 140 and risk assessment system 140 over communication network 130 and/or direct data link 115. For example, interface 147 may include one or more modulators, demodulators, multiplexers, demultiplexers, network communication devices, wireless devices, antennas, modems, and any other type of device configured to provide data communication between risk assessment system 140 and remote systems or components.

Additionally, interface 147 may include hardware and/or software components that allow a user to access information stored in risk assessment system 140 and/or risk assessment system 140. For example, risk assessment system 140 may include a data access interface that includes a graphical user interface (GUI) that allows users to access, configure, store, and/or download information to external systems, such as computers, PDAs, diagnostic tools, or any other type of external data device. Moreover, interface 147 may allow a user to access and/or modify information, such as operational parameters, operating ranges, and/or threshold levels associated with one or more component configurations stored in database 145.

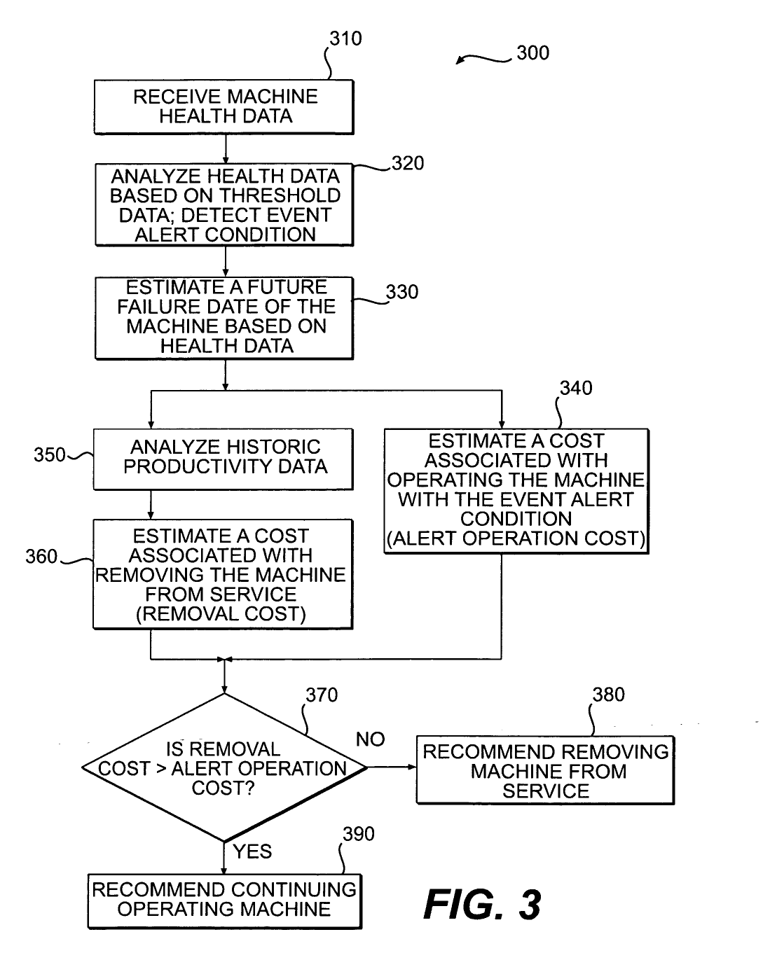

Processes and method consistent with the disclosed embodiments provide a system for estimating the risk(s) and/or costs associated with operating a machine under event alert conditions and evaluating these costs respective of repair costs, including productivity costs associated with lost productivity and/or replacement of the machine. FIG. 3 provides a flowchart 300 depicting an exemplary disclosed method of operation of the risk assessment system. As illustrated in FIG. 3, risk assessment system 140 may receive health data associated with one or more machines operating in a machine environment (Step 310). Health data, as the term is used herein, may include any type of operation data, either raw or processed, that may be indicative of the health of a machine or its constituent components. For instance, health data may include, for example, data indicative of fluid (such as fuel, oil, engine coolant, etc.) pressure, temperature, viscosity, or level; data indicative of component wear, such as bearing noise for an alternative, vibration data associated with a mechanical components, mechanical load and stress data; tire temperature and/or pressure data; data indicative of an electrical failure; or any other type of data indicative of the health of the machine or one or more of its subsystems. Health data may be received from one or more sensing devices 113a-e directly and automatically (e.g., in “real-time”) via communication module 111. Alternatively and/or additionally, health data may be collected (and stored for future use) in an on-board system, such as on-board controller 112. Risk assessment system 140 may receive and/or collect the health data by providing a request to on-board controller 112 and may subsequently receive the health data, in response to the request.

It is contemplated that health data may be received and/or collected from one or more off-board systems associated with the machine or machine environment. For example, health data may be collected form a back-end computer system that collects health data associated with the work environment and distributes the health data to other computer systems associated with the work environment. It is also contemplated that health data may be compiled and generated from raw data by an off-board system associated with the machine. This risk assessment system may subsequently receive the health data from the off-board system, alternatively and/or in addition to health data received from the machine.

Once the health data has been received, risk assessment system 140 may analyze health data based on predetermined threshold data and detect an event alert condition if the health data is inconsistent with the predetermined threshold data (Step 320). For example, risk assessment system may compare operation data associated with a particular fluid pressure, temperature, and viscosity with predetermined threshold data associated with the particular fluid. If the operation data is inconsistent with the threshold data, an event alert condition may be detected and an event alert may be provided. Event alert condition, as the term is used herein, refers to any type of condition that, if persistent, may be indicative of a potential future of the machine or one or more of its constituent components and/or subsystems. An event alert may identify a particular component with which the problematic health data is associated, as well as any particular operational aspects that caused the “triggering” of the event alert. According to one exemplary embodiment, event alerts may include one or more prognostic or “trouble” codes that specify particular abnormalities associated with component and/or machine operations. These trouble codes may be unique to the particular component and the particular abnormality associated with that component. Event alerts may range from non-critical (such as fluid level warning lights) to critical (such as mechanical stress data indicative of a broken machine frame) depending upon the amount of time prior to a future failure event. Thus, critical event alerts, if not addressed may result in imminent machine failure, while non-critical event alerts may go unresolved for several days or weeks. It is contemplated that varying degrees of event alert conditions exist corresponding to predetermined levels of data inconsistency. For example, if the operation data exceeds the threshold data by a first amount, the event alert condition may be defined as non-critical. However, if the operation data exceeds the threshold data by a second amount, the event alert condition may be deemed critical. One skilled in the art will recognize that additional, fewer, and different types of event alerts may be provided.

Once the health data has been analyzed and an event alert condition detected, risk assessment system 140 may estimate a future failure data of the machine, based on the event alert condition (Step 330). Risk assessment system 140 may determine the future failure date based on the health data and the type and nature of the event alert. For example, in response to the event alert, risk assessment system 140 may extract particular trouble codes associated with any event alerts. Risk assessment system 140 may estimate, based on the trouble codes and/or the severity of the event alert (critical or non-critical), a future failure date of the component or machine. This estimation may be based on historical operation and/or health data gathered, for example, from previous operations and/or field tests for the component, the machine, and/or machine type. Alternatively and/or additionally, the estimation of the future failure date may be derived from a look-up table or database associated with each component, based on failure test analysis associated with the machine. For purposes of the present disclosure, future failure date refers to any temporal indication (e.g., date, day and time, hour of operation, month, etc.) of a future failure of the machine associated with one or more event alert conditions, assuming these conditions continually and/or periodically persist.

Once a future failure date has been estimated, risk assessment system 140 may estimate a cost associated with operating the machine with the event alert condition (Step 340). This cost estimate may be based on operating the machine for a predetermined amount of time after the event alert was detected. One skilled in the art will recognize that costs associated with operating the machine under event alert conditions will vary with the type and severity of the condition. Thus, for certain event alert conditions, costs associated with operation of the machine after event alert detection may increase and/or escalate based on a potential damage that a the particular event alert condition may impose and the extent of the resulting repairs. For instance, operating a machine after a detection of an “engine overheat” event alert may result in significant damage to the machine, while operating the machine after detection of a “low tire pressure” event alert condition may result in very minor (if any) damage.

According to one embodiment, risk assessment system 140 may estimate the cost associated with operating the machine for a predetermined amount of time an event alert and/or until the future failure date of the machine. These costs may be based on predetermined and/or standard repair costs for particular event alert conditions at one or more intervals in the future, with the maximum repair cost being the repair or replacement of the component and/or subsystem resulting in the failure of that particular component and any resulting damage associated with that component failure. For example, costs associated with an engine overheat condition, as in the example above, may be gradual, depending upon the amount of time elapsed between the detection of the condition and the subsequent repair. Thus, operating the machine for a few minutes after an engine overheat condition is detected may only require repair or replacement of a radiator fan and engine coolant, while operating the machine for several hours may result in damage to the radiator or heat exchanger. Continued operation of the machine until the future failure date may result in damage to not only the cooling system, but the engine system and several other associated components. Accordingly, risk assessment system 140 may estimate costs associated with operating the machine under event alert conditions for several future intervals.

Risk assessment system 140 may also analyze historic productivity data associated with the machine (Step 350). For example, risk assessment system may analyze the historical productivity data associated with the machine to determine an amount of work performed by the machine during a predetermined time interval. Productivity data, as the term is used herein, refers to any data indicative of an amount of work performed or performable by the particular machine. Productivity data may include, for example, data indicative of an amount of material moved per unit time, an area of land cleared per unit time, an efficiency factor associated with the performance of a task, or any other data indicative of the productivity associated with a particular machine.

Once the historical productivity data has been analyzed, risk assessment system 140 may estimate a cost associated with removing the machine from service based on the historical productivity analysis (Step 360). For example, risk assessment system 140 may estimate the costs associated with removing the machine from service as a cost associated with the lost income (or any portion thereof) corresponding to the potential productivity of the machine had it otherwise not required removal. This estimation may be based the historical productivity levels of the machine, as well as forecast productivity levels associated with operating the machine under the event alert condition. Alternatively and/or additionally, risk assessment system 140 may estimate the machine removal costs as any costs incurred with renting a replacement machine during the machine removal period. According to yet another embodiment, costs associated with removing the machine from service may include an actual cost associated with the repair of the machine. It is also contemplated that one or more of the costs described above may be combined depending upon a desired removal scenario. For instance, in order to defray the costs associated with lost productivity of the machine, a project manager may rent a replacement machine during the repair duration of the defective machine. This may be particularly valuable in cases where loss of productivity poses a significant cost consideration to the project environment.

Once costs associated with both of removing the machine from service and operating the machine with the event alert condition (e.g., delaying action on the event alert, ignoring the event alert, etc.), risk assessment system may compare the costs (Step 370) and provide recommendations for responding to the event alert condition. For example, if costs associated with removing the machine from service exceed the costs of operating the machine under event alert conditions (Step 370: Yes), risk management system may recommend continuing operation of the machine under the event alert conditions (Step 390). Alternatively, if costs associated with removing the machine from service do not exceed costs associated with operating the machine under event alert conditions exceed (Step 370: No) risk management system 140 may recommend removing the machine from service in order to repair the machine and restore it back to appropriate operating condition (Step 380).

According to one embodiment, risk management system 140 may provide a plurality of recommendations associated with several options for addressing event alert conditions associated with a machine. Depending upon the future failure date, for example, risk management system 140 may provide recommendations offering daily or weekly options for addressing event alerts. For each interval, risk management system may provide prorated or adjusted costs, which have been predicted based on prognostic forecasting of damage and repair at that interval. Accordingly, these recommendations may provide a project manager with a forecast of potential costs associated with any trouble codes on the machine, enabling project managers to determine the most appropriate time to perform necessary repairs and/or maintenance, without jeopardizing potential project milestones or deadlines. Thus, recommendations from risk management system 140 may provide information as to the cost/benefits of delaying action until a future date, allowing a project manager to schedule machine maintenance according to a particular project schedule.

### INDUSTRIAL APPLICABILITY

Methods and systems associated with the disclosed embodiments provide project managers with recommendations for responding to event alerts associated with machine operations, including costs associated with multiple machine repair scenarios. Machine environments that employ processes and elements associated with the disclosed embodiments provide project managers with recommendations that include forecast costs associated with delaying machine maintenance until one or more future dates. These recommendations allow project managers to objectively compare costs associated with delaying action certain event alerts with costs associated with responding to the event alert immediately. These recommendations allow project managers to respond to more critical, potentially costly event alert conditions immediately, while delaying action on non-critical event alert conditions until a suitable future date.

Although the disclosed embodiments are described in association with machine environment 100, the disclosed system and method for evaluating risks associated with delaying maintenance described herein may be applicable to any environment where it may be desirable to evaluate costs associated with responding immediately to maintenance notifications versus delaying response until a future date. Specifically, the disclosed system and method for evaluating risks associated with delaying machine maintenance may compare present repair and removal costs associated with responding to machine event alerts immediately with future costs associated with delaying response. This cost analysis solution may enable project managers to implement the most cost effective maintenance schedule for a machine, based on the actual operational characteristics and equipment needs of a particular machine environment.

The presently disclosed system and method for evaluating risks associated with delaying machine maintenance may have several advantage. First, because risk assessment system 140 uses health and/or prognostic data collected from the machine during real-time machine operations, risk assessment system 140 may estimate machine maintenance costs schedules based on the actual health needs of the machine. This real-time, prognostic-based cost analysis may provide a more accurate determination of a machine's maintenance needs and, therefore, a more accurate cost schedule, than conventional systems that simply determine maintenance requirement based on “typical” lifespan data associated with machine components.

Additionally, by predicting present and future maintenance costs and schedules based on health data derived from real-time machine operations as opposed to “estimated” component lifespan, the presently disclosed system may limit unnecessary and costly machine maintenance to repair or replace components at or near the end of their lifespan. Accordingly, the presently disclosed system may enable the combination of scheduled maintenance intervals associated with “expiring” components with unscheduled maintenance associated with event alert conditions during one or more future repair sessions, limiting frequency of machine repair sessions. As a result, project managers, based on recommendations from risk assessment system 140, may elect to delay action on certain event alert conditions until future scheduled maintenance periods, thereby reducing the costs associated with removing the machine for maintenance on multiple occasions.

It will be apparent to those skilled in the art that various modifications and variations can be made to the disclosed system and method for evaluating risks associated with delaying machine maintenance. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for determining risk associated with delaying machine maintenance comprising:
receiving health data associated with a machine;
analyzing the health data based on predetermined threshold data to detect an event alert condition;
estimating a future failure date of a machine component based on the health data analysis;
analyzing historic productivity data associated with the machine;
estimating a cost associated with operating the machine with the event alert condition for a predetermined amount of time;
estimating a cost associated with removing the machine from service based on historic productivity analysis;
analyzing the estimated cost associated with removing the machine from service based on the estimated cost associated with operating the machine with the event alert condition; and
providing a machine maintenance recommendation based on the cost analysis.

2. The method of claim 1, wherein analyzing the health data includes providing an event alert if the health data is inconsistent with the predetermined threshold data, wherein the event alert corresponds with a prognostic code associated with one or more potential problems with the machine.

3. The method of claim 1, wherein estimating the cost associated with removing the machine from service includes determining, based on the historical productivity data, a value associated with a loss in productivity corresponding to removal of the machine during an estimated maintenance duration.

4. The method of claim 3, wherein the value associated with the loss in productivity includes one or more of a monetary value associated with an average income generated by the machine corresponding to the estimated maintenance duration.

5. The method of claim 1, wherein estimating the cost associated with removing the machine from service includes determining a cost associated with replacing the machine with a second machine.

6. The method of claim 1, wherein estimating the cost associated with removing the machine from service includes estimating a current cost associated with a machine maintenance.

7. The method of claim 1, wherein estimating a cost associated with operating the machine with the event alert condition includes estimating a future cost associated with a future machine maintenance.

8. The method of claim 7, wherein estimating the future cost includes:
estimating a future duration associated with the machine maintenance; and
determining, based on the historical productivity data, a value associated with a loss in productivity corresponding to removal of the machine during the estimated future maintenance duration.

9. The method of claim 1, wherein providing the machine maintenance recommendation includes:
providing a recommendation to remove the machine from service if the estimated cost associated with operating the machine until the future failure date exceeds the estimated cost associated with removing the machine from service; and
providing a recommendation to operate the machine until the future failure date if the estimated cost associated with removing the machine from service exceeds the estimated cost associated with operating the machine until the future failure date.

10. A computer-readable medium for use on a computer system, the computer-readable medium having computer executable instructions for performing the method of claim 1.

11. A system for evaluating risks associated with delaying machine maintenance comprising:
a communication interface for receiving health data associated with a machine;
a processor, communicatively coupled to the communication interface and configured to:
analyze the health data based on predetermined threshold data;
estimate a future failure date of a machine component based on the health data analysis;
analyze historic productivity data associated with the machine;
estimate a cost associated with operating the machine with an event alert condition for a predetermined amount of time;
estimate a cost associated with removing the machine from service based on historic productivity analysis;
analyze the estimated cost associated with removing the machine from service based on the estimated cost associated with operating the machine with the event alert condition; and
provide a machine maintenance recommendation based on the cost analysis.

12. The system of claim 11, wherein analyzing the health data includes providing an event alert if the health data is inconsistent with the predetermined threshold data, wherein the event alert corresponds with a prognostic code associated with one or more potential problems with the machine.

13. The system of claim 11, wherein estimating the cost associated with removing the machine from service includes determining, based on the historical productivity data, a value associated with a loss in productivity corresponding to removal of the machine during an estimated maintenance duration.

14. The system of claim 11, wherein estimating the cost associated with removing the machine from service includes at least one of:
determining a cost associated with replacing the machine with a second machine or estimating a current cost associated with a machine maintenance; or
estimating a future cost associated with a future machine maintenance.

15. The system of claim 14, wherein estimating the future cost includes:
estimating a future duration associated with the machine maintenance; and
determining, based on the historical productivity data, a value associated with a loss in productivity corresponding to removal of the machine during the estimated future maintenance duration.

16. The system of claim 11, wherein providing the machine maintenance recommendation includes:
providing a recommendation to remove the machine from service if the estimated cost associated with operating the machine until the future failure date exceeds the estimated cost associated with removing the machine from service; and
providing a recommendation to operate the machine until the future failure date if the estimated cost associated with removing the machine from service exceeds the estimated cost associated with operating the machine until the future failure date.

17. A machine environment comprising:
a machine operating in the machine environment;
a communication module for communicating data associated with the machine;
at least one monitoring device for collecting health data associated with at least one component of the machine and providing the health data to the communication module;
a system for evaluating risks associated with delaying machine maintenance communicatively coupled to the communication module and configured to:
receive health data associated with a machine;
analyze the health data based on predetermined threshold data;
estimate a future failure date of a machine component based on the health data analysis;
estimate a cost and duration associated with repairing the machine;
analyze historic productivity data associated with the machine;
estimate a cost associated with removing the machine from service based on historic productivity analysis and the estimated maintenance duration;
compare the estimated cost associated with removing the machine from service with the estimated cost associated with the machine maintenance; and
provide a recommendation to remove the machine from service if the estimated cost associated with operating the machine until the future failure date exceeds the estimated cost associated with removing the machine from service; and
provide a recommendation to operate the machine until the future failure date if the estimated cost associated with removing the machine from service exceeds the estimated cost associated with operating the machine until the future failure date.

18. The machine environment of claim 17, wherein analyzing the health data includes providing an event alert if the health data is inconsistent with the predetermined threshold data, wherein the event alert corresponds with a prognostic code associated with one or more potential problems with the machine.

19. The machine environment of claim 17, wherein estimating the cost associated with removing the machine from service includes determining, based on the historical productivity data, a value associated with a loss in productivity corresponding to removal of the machine during an estimated maintenance duration.

20. The machine environment of claim 17, wherein estimating the cost associated with removing the machine from service includes at least one of:
determining a cost associated with replacing the machine with a second machine or estimating a current cost associated with a machine maintenance; or
estimating a future cost associated with a future machine maintenance.
